(19) United States
(12) Patent Application Publication
(10) Pub. No.: US 2009/0102419 A1
(43) Pub. Date: Apr. 23, 2009

(54) WIRELESS CHARGER DECREASED IN VARIATION OF CHARGING EFFICIENCY

(76) Inventors: Gwang-Hee Gwon, Gyeonggi-do (KR); Dong-Young Park, Seoul (KR); Sung-Wook Choi, Gyeonggi-do (KR); Sub Han, Gyeonggi-do (KR); Sung-Wook Moon, Seoul (KR)

Correspondence Address: STROOCK & STROOCK & LAVAN LLP, 180 MAIDEN LANE, NEW YORK, NY, 10038, US

(21) Appl. No.: 11/996,621

(22) PCT Filed: May 4, 2006
(86) PCT No.: PCT/KR2006/001706

§ 371 Date: Jun. 16, 2008

(30) Foreign Application Priority Data
Jul. 27, 2005 (KR) 1020050068638
May 2, 2006 (KR) 1020050039650

(51) Int. Cl. H02J 7/00

(52) U.S. Cl. 320/108

(57) ABSTRACT

A wireless charger charges a storage battery of a portable electronic device in a wireless manner (non-contacting or contact-less) so that a variation of charging efficiency is not serious though the storage battery is placed any position of the wireless charger. The wireless charger is provided with a primary coil for generating a magnetic field so as to charge a subject, which is provided with a secondary coil, by means of inductive coupling with the secondary coil. The primary coil includes an outer coil arranged with a predetermined winding number and a predetermined size; and at least one inner coil arranged to be included inside the outer coil. The outer coil and the inner coil are arranged so that, when a primary current is applied to the outer coil and the inner coil, magnetic fluxes generated in the outer coil and the inner coil are formed in the same direction.

### TECHNICAL FIELD

The present invention relates to a wireless charger (for example, using a non-contacting or contact-less method), and more particularly to a wireless charger having a structure capable of decreasing a variation of charging efficiency depending on a position where a subject to be charged is placed.

### BACKGROUND ART

Generally, a potable electronic device such as cellular phones, notebooks, PDA and so on is provided with a storage battery therein so that a user may use with moving. However, such a potable electronic device is separately provided with a charger for charging the storage battery, and the charger is connected to a common power source to supply a charging current to a storage battery of the potable electronic device, and thus to charge the storage battery. Meanwhile, in order that the charger may supply a charging current to the storage battery of the potable electronic device, a charging body of the charger should be electrically connected to the storage battery of the potable electronic device. In order to electrically connect the charging body with the storage battery of the portable electronic device, contact terminals are separately provided to the charging body and the portable electronic device or the storage battery in a wire charger (for example, using a contacting method). Thus, in order to charge the storage battery of the portable electronic device, the contact terminal of the portable electronic device or the storage battery and the contact terminal of the charger should be inter-connected.

However, in the charger using the contacting method in which contact terminals are provided to the charging body and the portable electronic device or the storage battery, the contact terminals are protruded out, thereby deteriorating the appearance and possibly causing inferior contact due to contamination of the contact terminals caused by external impurities. On occasions, a short circuit may happen due to carelessness of a user, which results in complete discharging of the storage battery.

In order to solve the above problems, there has been developed a method in which a storage battery of a portable electronic device is electrically coupled to a charging body in a wireless manner (or, in a contact-less method) for charging energy of the charging body.

In the contact-less charging method, a primary circuit operated using high frequency is configured in the charging body, and a secondary circuit is configured to the storage battery side, namely in the portable electronic device or the storage battery so that current, or energy, of the charging body is supplied to the storage battery of the portable electronic device by means of inductive coupling. The contact-less charging method using inductive coupling is already used in some applications (e.g., electric toothbrushes, electric shavers and so on).

However, in case the contact-less charging method is to be applied to portable electronic devices such as cellular phones, portable MP3 players, CD players, MD players, cassette tape players, notebooks, PDA and so on, volume and weight added to the storage battery side should be small, and a variation of charging efficiency depending on a position where the portable electronic device or the storage battery is placed should be decreased. That is to say, for compatibility with portable electronic devices with various shapes and sizes (for example, when seeing just cellular phones with a constant rated voltage of a storage battery, there are vary various shapes and sizes), a charging body should be designed to have a slightly greater size than a subject to be charged, and it is not acceptable if its shape and configuration is fit only with a specific subject. Furthermore, if considering a structure that charges at least two portable electronic devices or storage batteries at the same time, the size of the charging body is further increased, and accordingly a significant variation is caused on a position of the portable electronic device or the storage battery, which is a subject to be charged by the charging body. However, an intensity of a magnetic field (or, a magnetic flux density) generated by the primary circuit of the charging body (or, a primary coil) is rapidly decreased as a distance from the coil is increased. Thus, the charging efficiency that is proportional to the magnetic flux density to be inductively coupled has a significant variation according to a position of the subject to be charged by the primary coil. In addition, if the subject to be charged is not in a proper position, a time taken for complete charging is seriously increased, and in the worst case, the charging is substantially not made.

In particular, differently from electric toothbrushes or electric shavers that are used in a very short time but left alone substantially all day long, potable electronic devices such as cellular phones, PDA, MP3 players and so on should be charged in a short time such as during a bedtime, so the variation of charging efficiency depending on a position is much more serious.

Thus, in order to widely use a wireless charger for portable electronic devices such as cellular phones, it is urgently needed to decrease a variation of charging efficiency according to a position where a subject to be charged is placed.

### DISCLOSURE OF INVENTION

### Technical Problem

The present invention is designed in consideration of the above problems, and therefore it is an object of the invention to provide a wireless charger in which a variation of charging efficiency according to a position of a subject to be charged with respect to the wireless charger is decreased.

### Technical Solution

In order to accomplish the above object, the present invention provides a wireless charger provided with a primary coil for generating a magnetic field so as to charge a subject, which is provided with a secondary coil, by means of inductive coupling with the secondary coil, wherein the primary coil includes an outer coil arranged with a pre-determined winding number and a predetermined size; and at least one inner coil arranged to be included inside the outer coil, wherein the outer coil and the inner coil are arranged so that, when a primary current is applied to the outer coil and the inner coil, magnetic fluxes generated in the outer coil and the inner coil are formed in the same direction.

Here, the outer coil and the inner coil may be arranged so that their centers are identical.

In addition, there may be provided at least two inner coils so that the inner coils are subsequently arranged one in another.

In another aspect of the present invention, there is also provided a wireless charger provided with a primary coil for generating a magnetic field so as to charge a subject, which is provided with a secondary coil, by means of inductive coupling with the secondary coil, wherein the primary coil is arranged with a predetermined winding number and a predetermined size, and wherein a density profile of magnetic flux formed when a primary current is applied to the primary coil has at least three local maximum points inside the primary coil, seen along a traversing line of the primary coil.

In still another aspect of the present invention, there is also provided a wireless charger provided with a primary coil for generating a magnetic field so as to charge a subject, which is provided with a secondary coil, by means of inductive coupling with the secondary coil, wherein the primary coil is arranged with a predetermined winding number and a predetermined size, and wherein a density of magnetic flux formed when a primary current is applied to the primary coil is at least 50% of a maximum value of the magnetic flux density at any point inside the primary coil.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a perspective view showing that a storage battery of a portable electronic device is charged using a wireless charger according to an embodiment of the present invention;

FIG. 2 is a schematic plane view showing a primary coil of the wireless charger according to an embodiment of the present invention;

FIG. 3 is a schematic view showing magnetic flux density profiles of magnetic fields generated by primary coils of wireless chargers according to the prior art and the present invention;

FIG. 4 is a schematic plane view showing a modification of the primary coil of the wireless charger according to the present invention;

FIG. 5 is a diagram illustrating experiments in which a primary coil is configured as a wireless charger of a cellular phone storage battery according to an embodiment of the present invention, and then an inductive power is measured with changing a position of a secondary coil of the cellular phone storage battery; and

FIG. 6 is a graph of an inductive power profile, which shows experiment results according to the configuration of FIG. 5.

### BEST MODE FOR CARRYING OUT THE INVENTION

Hereinafter, preferred embodiments of the present invention will be described in detail with reference to the accompanying drawings.

Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 1 is a perspective view showing that a storage battery of a portable electronic device is charged using a wireless charger according to an embodiment of the present invention.

As shown in FIG. 1, the wireless charger 10 of this embodiment includes a pad 11 for placing a portable electronic device 20, which is a subject to be charged, or its storage battery thereon, a circuit unit 12 mounted in the wireless charger 10 and having various primary circuits for the wireless charger integrated on a substrate, and a status indicator 13 for indicating a charging status.

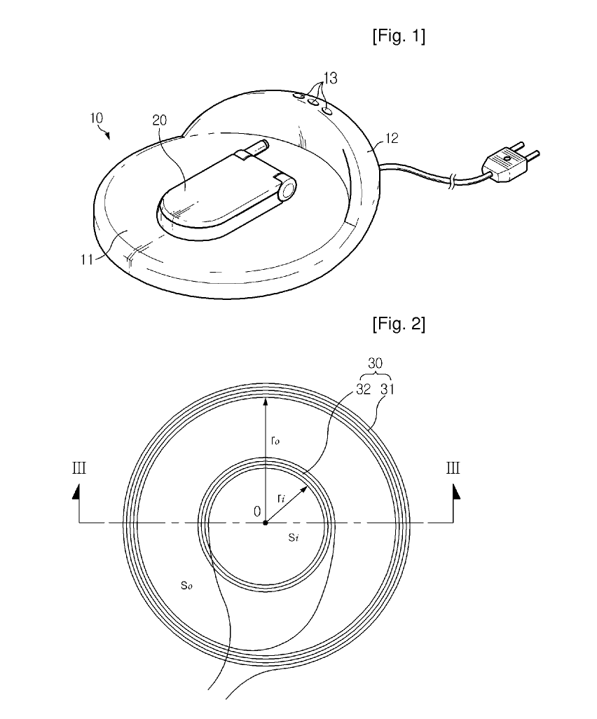

A primary coil 30 (see FIG. 2) for generating a magnetic field when a primary current of high frequency is applied thereto is arranged on the pad 11 having a substantially disk shape. In the circuit unit 12, a rectifier for generating a desired primary current of high frequency from a common AC power, SMPS (Switching Mode Power Supply), a communication circuit for communication with a secondary battery, and a control circuit for controlling them are mounted. The status indicator 13 is used for indicating whether a power source is connected, whether or not to be in charging, whether or not to be completely charged, and so on, and it is composed of suitable number and color of LEDs.

The shape and arrangement of the primary coil, explained later, are essential to the present invention, but configurations, arrangements and shapes of the pad 11, the circuit unit 12 and the status indicator 13 may be changed as desired.

For example, the whole shape of the wireless charger 10 including the pad 11 and the circuit unit 12 may be a polygonal shape such as a rectangular or hexagonal shape as well as a disk shape, and the circuit unit 12 may not be protruded. Furthermore, though it is illustrated in FIG. 1 that the wireless charger 10 is evenly placed on the ground, the wireless charger may have a wall-hanging structure so that the portable electronic device 20 is received in a pocket or a drawer.

In addition, the circuits mounted in the circuit unit 12 may not have a rectifier in case it uses a DC power like a cigar jack of an automobile, not using a common AC power of 110V or 220V.

Furthermore, the status indicator 13 may use a small LCD element instead of LED, and it may also be replaced with a speaker that sends a voice or an alarm.

A storage battery (or, a secondary battery) is mounted to a side of the cellular phone 20 facing the pad 11 when being placed on the pad 11, and a secondary coil (not shown) inductively coupled with the primary coil 30 arranged in the pad 11 is mounted in the storage battery so as to generate an inductive current.

Meanwhile, though it is illustrated in FIG. 1 that the portable electronic device is the cellular phone 20 as an example, the present invention is not limited thereto but may be applied to various portable electronic devices such as PDA, portable MP3 players, CD players and so on. In addition, though it has been illustrated that the entire cellular phone 20 is placed on the wireless charger 10 for charging, it is also possible that only the storage battery of the cellular phone is placed thereon for charging.

Now, configuration and arrangement of the primary coil 30 of this embodiment will be explained in detail with reference to FIG. 2.

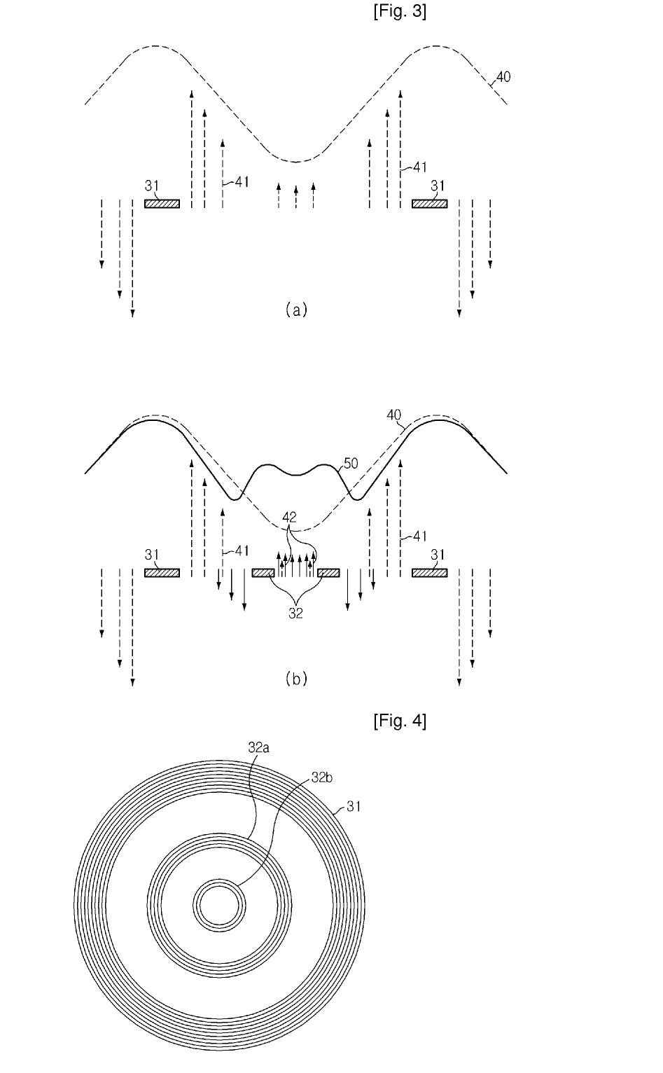

As shown in FIG. 2, the primary coil 30 formed in the pad 11 is composed of an outer coil 31 and an inner coil 32. The outer coil 31 is arranged with a predetermined winding number and a radius of rₒ, and the inner coil 32 is arranged with a predetermined winding number and a radius of rᵢ. Meanwhile, the winding number and radius of each coil 31, 32 are not exactly depicted in the drawings, but simplified for the ease of explanation. In the drawings, Sᵢ and Sₒ are respectively concentric areas of the inner coil 32 and the outer coil 31, which respectively have relations: Sᵢ=πrᵢ² and Sₒ=πrₒ². Here, the winding number, radius and concentric area of each coil are determined in consideration of a rating of the storage battery to be charged, rating and frequency of the charging power, impedance of the coil, shape and size of the secondary coil, and so on, and also in consideration of a magnetic flux density profile explained later with reference to FIG. 3.

Meanwhile, though the outer coil 31 and the inner coil 32 are all configured in a planar spiral shape in FIG. 2, the coils may have a polygonal shape such as a square or a hexagon according to the shape of the pad 11 or the secondary coil. The outer coil 31 and the inner coil 32 may also have different shapes from each other. In addition, though the outer coil 31 and the inner coil 32 are arranged in a concentric circle with the same center in FIG. 2, their centers may not be identically matched. Furthermore, though it is illustrated in FIG. 2 that there is only one inner coil 32, it is also possible that at least two inner coils 32a, 32b are subsequently arranged one in another as shown in FIG. 4.

In addition, each coil 31, 32 is generally made of a copper wire coated with an insulating material on its surface, but its material is not specially restricted if it has good conductivity like gold, silver, aluminum and so on. Furthermore, each coil 31, 32 may be configured so that one conductive wire is wound, but a Litz wire in which a plurality of single wires are aggregated is preferably used for charging using high frequency current.

In addition, each coil 31, 32 may have a conductor pattern, not in a shape in which a conductive wire is wound. That is to say, each coil 31, 32 may have a conductor pattern in which a metal thin film with good conductivity such as copper and aluminum is laminated on a PCB substrate or a flexible insulating film (or, a substrate film) made of such as polyimide, and then it is etched into a pattern as shown in FIG. 2 or 4. Furthermore, though the above explanation was made about the primary coil of the present invention, the secondary coil, namely the coil of the portable electronic device, may also be configured in a shape in which a conductive wire such as a copper wire is wound or in a conductor pattern like the primary coil 31, 32 of the present invention. Thus, the term ‘coil’ has a broad meaning in the specification and claims, which includes all coil-shaped patterns regardless of the fact that a conductive wire is sound or a metal thin film is etched.

The outer coil 31 and the inner coil 32 are connected in series as shown in FIG. 2 so that a primary current is applied thereto, but they may also be separately formed so that a primary current is applied thereto independently. Here, it should be noted that all coils should be arranged so that, when a primary current is applied to the primary coil 30, magnetic fields generated in all coils should be directed in the same direction (its reason will be explained later).

Now, the principle of the present invention will be described in more detail with reference to FIG. 3. FIG. 3 is a schematic view showing an intensity (or, magnetic flux density) profile, seen along the line traversing the outer coil 31 and the inner coil 32 (or, the line III-III of FIG. 2) when a primary current is applied to the primary coil 30, where (a) of FIG. 3 shows the case of a conventional primary coil without any inner coil, and (b) of FIG. 3 shows the case including the outer coil 31 and the inner coil 32 according to the present invention as shown in FIG. 2.

First, in case there is no inner coil as shown in (a) of FIG. 3, if a primary current is applied to the primary coil (or, the outer coil) 31, a magnetic field is generated in a direction according to the right-hand screw rule (or, Ampere's law), and an intensity (or, a magnetic flux density) of the magnetic field at a certain point near the coil 31 is in inverse proportion to the cube of a distance from the coil 31. Thus, as indicated by an arrow 41, a magnetic flux density 41 is rapidly reduced as a distance from the coil 31 is increased, and a magnetic flux density in the coil 31 has a profile as indicated by a dotted line 40. As seen from the magnetic flux density 40, the density of magnetic flux generated in the coil 31 has a maximum value at a position closest to the coil 31, and has a minimum value at a center in the coil. Thus, a charging efficiency may be abruptly deteriorated and a time taken for perfect charging may be rapidly increased according to a position where the cellular phone 20 or the storage battery is placed, though it is related to an intensity of the primary current or a radius of the coil 31.

Meanwhile, in (b) of FIG. 3 in which the inner coil 32 exists, a magnetic field is formed by the inner coil 32, and its magnetic flux density is decreased in inverse proportion to the cube of a distance from the inner coil 32, as indicated by an arrow 42. Thus, the entire magnetic flux density made by the outer coil 31 and the inner coil 32 becomes the sum of magnetic flux densities of both coils 31, 32, which shows a profile as indicated by a solid line 50. This entire magnetic flux density profile 50 is slightly decreased in a region out of the inner coil 32 rather than the profile 40 made by only the outer coil since it is offset by the magnetic flux formed by the outer coil 31, but it is reinforced in a region inside the inner coil 32, thereby giving a unique profile that also has a maximum point near the center of the primary coil. In addition, the entire magnetic flux density profile 50 is minimal near an outer portion of the inner coil 32, but this minimum value is greater than the minimum value of the magnetic flux density profile 40 formed only by the outer coil 31. Thus, the entire magnetic flux density profile 50 is flattened as a whole in comparison to the magnetic flux density profile 40 formed by only the outer coil, so a variation of the magnetic flux density is further decreased inside the primary coil (or, the outer coil) 31 and accordingly a variation of the inductive power and a variation of charging efficiency are also further decreased, resulting in great reduction of a variation of the time taken for perfect charging.

Here, the outer coil 31 and the inner coil 32 should be arranged so that magnetic fields generated when a primary current is applied thereto are in the same direction as mentioned above because magnetic flux densities 41, 42 formed by the coils 31, 32 are reinforced near the centers of the coils 31, 32 to increase a minimum value of the entire magnetic flux density.

Meanwhile, the entire magnetic flux density profile 50 is changed depending on radii, winding numbers and impedances of the outer coil 31 and the inner coil 32, intensity and frequency of the primary current and so on, but its basic form shown in FIG. 3 is kept. However, specific positions and values of maximum and minimum points may be adjusted by suitably controlling radii, winding numbers and impedances of the coils, intensity and frequency of the primary current and so on. By controlling the entire magnetic flux density profile 50 as mentioned above, it is possible to set a minimum magnetic density value in the primary coil 30 to a desired level. Preferably, if a minimum value of the entire magnetic flux density is set to be equal to or greater than 50% of the minimum value, it is possible to decrease a variation of charging efficiency, and thus shorten a variation of time taken for perfect charging. More preferably, if the minimum value of the entire magnetic flux density is set to be equal to or greater than 70% of the maximum value, a time taken for perfect charging may be further shortened, which is useful to prepare the worst.

Now, a desirable example of configuration and arrangement of the primary coil will be explained based on the case that a storage battery of a cellular phone is charged. However, this example is provided just for illustration purpose only, and the present invention is not limited to this example. Furthermore, if a secondary subject to be charged is not the storage battery of the cellular phone but a storage battery of another kind of portable electronic device such as PDA and notebook, the following arrangement example may be changed in various ways.
Input Power: AC 220V
Frequency of Charging Current: 80 kHz
Intensity of Charging Current: 110 to 160 A
DC Resistance of Inner Coil: 0.1 to 0.5Ω
DC Resistance of Outer Coil: 1.0 to 3.0Ω
Radius Ratio of Coils (rᵢ/rₒ): 0.1 to 0.9
Concentric Area Ratio of Coils (Sᵢ/Sₒ): 0.01 to 0.81
Winding Number of Inner Coil: 5 to 15
Winding Number of Outer Coil: 40 to 60
AC (1 kHz˜1 MHz) Resistance of Inner Coil: 0.1 to 0.4Ω
AC (1 kHz˜1 MHz) Resistance of Outer Coil: 2.0 to 20
Inductance of Inner Coil: 4.7 to 5.0 μH
Inductance of Outer Coil: 240 to 250 μH

Meanwhile, more specifically, after configuring a primary coil and a secondary coil as illustrated in FIG. 5 and the following table 1 using an input power of 220V and a frequency of charging current of 80 kHz, an inductive power profile proportional to its magnetic flux density and maximum and minimum values of the inductive power were measured. Here, a multi coil was prepared by connecting an outer coil and an inner coil, made of copper material in a Litz shape, in series for preparing the primary coil 31, 32, and a circular single coil made of copper material in a Litz shape was used as the secondary coil 21.

TABLE 1

| Parameters | Primary Coil | Secondary | |
|---|---|---|---|
| of Coil | (31, 32) | Coil (21) | Remark |
| DC Resistance | Inner Coil: 0.1 | 1.3 | |
| (Ω) | Outer Coil: 2.0 | | |
| Inductance (μH) | 373.3(1 kHz) | 38(80 kHz) | |
| Winding Number | Inner Coil: 12 | 25 | |
| | Outer Coil: 50 | | |
| Diameter of Coil | 0.15 | 0.08 | Diameter of |
| Wire (mm) | | | Unit Wire |
| | | | of Litz Wire |
| Thickness of Coil | 2.5 | 0.3~0.4 | Thickness |
| (mm) | | | perpendicular |
| | | | to the plane |
| | | | of FIG. 5 |
| Inner Radius | Inner Coil (rᵢ): 18 | r′: 15 | |
| (mm) | Outer Coil (rₒ): 35 | | |
| Outer Radius | Inner Coil (Rᵢ): 19 | R′: 20 | |
| (mm) | Outer Coil (Rₒ): 37 | | |
| Interval between | 16 | — | |
| Coils (d)(mm) | | | |

In addition, in order to compare the effects of the present invention with those of a conventional one, a primary coil was configured in the same way as the above embodiment except that an inner coil is excluded, as a comparative example, and then its inductive power profile and maximum and minimum values of the inductive power were measured.

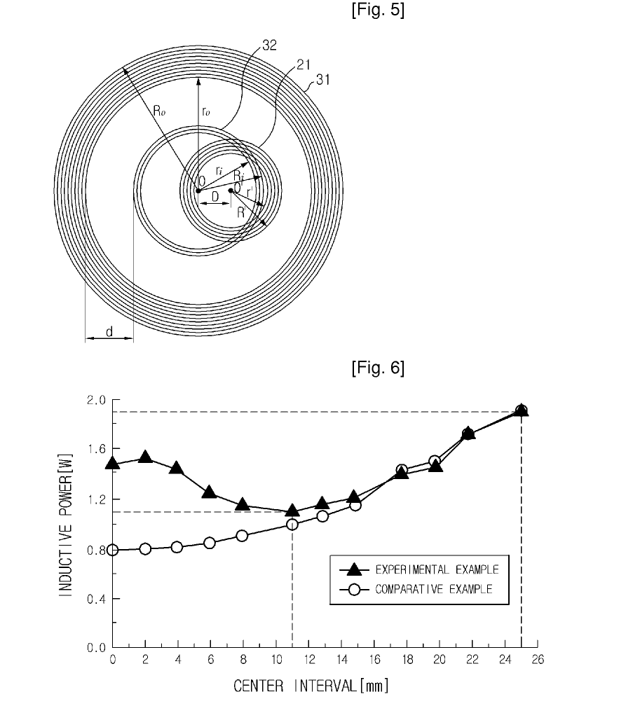

In the above examples prepared as mentioned above, voltage, current and power induced to the secondary coils of this experimental example and the comparative example were measured as listed in the following table 2, and profiles of inductive powers were as shown in FIG. 6.

TABLE 2

| | Experimental Example | | | Comparative Example | | |
|---|---|---|---|---|---|---|
| Inter-Center | (dual coil) | | | (single coil) | | |
| Interval | Voltage | Current | Power | Voltage | Current | Power |
| (D)(mm) | (V) | (mA) | (W) | (V) | (mA) | (W) |
| 25 | 5.07 | 366 | 1.9 | 5.07 | 366 | 1.86 |
| 22 | 4.84 | 366 | 1.8 | 4.71 | 366 | 1.72 |
| 20 | 4.01 | 366 | 1.5 | 4.11 | 366 | 1.50 |
| 18 | 3.83 | 366 | 1.4 | 3.92 | 366 | 1.43 |
| 15 | 3.28 | 366 | 1.2 | 5.80 | 200 | 1.16 |
| 13 | 3.19 | 366 | 1.2 | 5.31 | 200 | 1.06 |
| 11 | 3.00 | 366 | 1.1 | 4.98 | 200 | 1.00 |
| 8 | 3.17 | 366 | 1.2 | 4.52 | 200 | 0.90 |
| 6 | 3.43 | 366 | 1.3 | 4.26 | 200 | 0.85 |
| 4 | 3.95 | 366 | 1.4 | 4.12 | 200 | 0.82 |
| 2 | 4.18 | 366 | 1.5 | 4.00 | 200 | 0.80 |
| 0 | 4.08 | 366 | 1.5 | 3.98 | 200 | 0.80 |

As seen from the table 2 and FIG. 6, the secondary inductive power according to the experimental example of the present invention has a maximum value of 1.9 W and a minimum value of 1.1 W, and thus the minimum value reaches about 58% of the maximum value. Meanwhile, the secondary inductive power of the comparative example shows a maximum value of 1.86 W and a minimum value of 0.8 W, so the minimum value is just about 43% of the maximum value.

From the above experimental and comparative examples, it would be understood that a variation of charging efficiency is greatly reduced in a wireless charger provided with the primary coil according to the present invention.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

As described above, the wireless charger according to the present invention has a primary coil with a multi structure composed of an outer coil and an inner coil, thereby supplementing a rapidly-decreased magnetic flux density near the inner center of the outer coil with a magnetic flux formed by the inner coil. Thus, a variation of magnetic flux is significantly decreased inside the primary coil, and accordingly a variation of charging efficiency according to a position where a storage battery to be charged is placed is greatly decreased.

1. A wireless charger provided with a primary coil for generating a magnetic field so as to charge a subject, which is provided with a secondary coil, by means of inductive coupling with the secondary coil, wherein the primary coil includes:
an outer coil arranged with a predetermined winding number and a predetermined size; and
at least one inner coil arranged to be included inside the outer coil,
wherein the outer coil and the inner coil are arranged so that, when a primary current is applied to the outer coil and the inner coil, magnetic fluxes generated in the outer coil and the inner coil are formed in the same direction.

2. The wireless charger according to claim 1,
wherein centers of the outer coil and the inner coil are identical.

3. The wireless charger according to claim 1,
wherein there are provided at least two inner coils, and the at least two inner coils are subsequently arranged one in another.

4. The wireless charger according to any of claims 1 to 3,
wherein the outer coil and/or the inner coil are wound into a shape of a substantially planar circle.

5. The wireless charger according to any of claims 1 to 3,
wherein the outer coil and/or the inner coil are wound into a shape of a substantially planar polygon.

6. The wireless charger according to any of claims 1 to 3,
wherein the outer coil and/or the inner coil are configured by winding at least one conductive wire made of a material selected from the group consisting of gold, silver, copper and aluminum.

7. The wireless charger according to claim 6,
wherein the outer coil and/or the inner coil are composed of Litz wire.

8. The wireless charger according to any of claims 1 to 3,
wherein the outer coil and/or the inner coil are configured with a conductor pattern formed by patterning on a substrate film.

9. The wireless charger according to any of claims 1 to 3,
wherein the outer coil and the inner coil are connected in series with each other.

10. The wireless charger according to any of claims 1 to 3,
wherein the outer coil and the inner coil are indirectly connected with each other.

11. The wireless charger according to any of claims 1 to 3,
wherein a density profile of magnetic flux formed when a primary current is applied to the primary coil has at least three local maximum points inside the primary coil, seen along a traversing line of the primary coil.

12. The wireless charger according to any of claims 1 to 3,
wherein the inner coil is arranged between the outer coil and a point at which a density of magnetic flux formed by the outer coil when a primary current is applied only to the outer coil is 50% of its maximum value.

13. A wireless charger provided with a primary coil for generating a magnetic field so as to charge a subject, which is provided with a secondary coil, by means of inductive coupling with the secondary coil,
wherein the primary coil is arranged with a predetermined winding number and a predetermined size, and
wherein a density profile of magnetic flux formed when a primary current is applied to the primary coil has at least three local maximum points inside the primary coil, seen along a traversing line of the primary coil.

14. The wireless charger according to claim 13,
wherein, in the magnetic flux density profile inside the primary coil, a minimum value of a magnetic flux density is at least 50% of a maximum value of the magnetic flux density.

15. The wireless charger according to claim 13, wherein the primary coil includes:
an outer coil arranged with a predetermined winding number and a predetermined size; and
at least one inner coil arranged to be included inside the outer coil,
wherein the outer coil and the inner coil are arranged so that, when a primary current is applied to the outer coil and the inner coil, magnetic fluxes generated in the outer coil and the inner coil are formed in the same direction.

16. A wireless charger provided with a primary coil for generating a magnetic field so as to charge a subject, which is provided with a secondary coil, by means of inductive coupling with the secondary coil,
wherein the primary coil is arranged with a predetermined winding number and a predetermined size, and
wherein a density of magnetic flux formed when a primary current is applied to the primary coil is at least 50% of a maximum value of the magnetic flux density at any point inside the primary coil.

17. The wireless charger according to claim 16,
wherein a magnetic flux density formed when a primary current is applied to the primary coil is at least 70% of a maximum value of the magnetic flux density at any point inside the primary coil.

18. The wireless charger according to claim 16,
wherein a profile of the magnetic flux density, seen along a traversing line of the primary coil, has at least three local maximum points inside the primary coil.

19. The wireless charger according to claim 16, wherein the primary coil includes:
an outer coil arranged with a predetermined winding number and a predetermined size; and
at least one inner coil arranged to be included inside the outer coil,
wherein the outer coil and the inner coil are arranged so that, when a primary current is applied to the outer coil and the inner coil, magnetic fluxes generated in the outer coil and the inner coil are formed in the same direction.
